(19) United States
(12) Patent Application Publication
(10) Pub. No.: US 2006/0181496 A1
(43) Pub. Date: Aug. 17, 2006

(54) Display units

(75) Inventors: Jian-Shen Yu, Hsinchu City (TW); Chien-Sheng Yang, Jhudong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/120,473

(22) Filed: May 2, 2005

(30) Foreign Application Priority Data
Feb. 17, 2005 (TW) 94104607

(51) Int. Cl. G09G 3/36

(52) U.S. Cl. 345/92

(57) ABSTRACT

A display unit for a display panel having a display array. The display array is formed by at least one data line and at least one scan line. During a frame, a voltage of a video signal is provided to the display unit. Before a subsequent frame, the voltage of the video signal stored in a storage capacitor within the display unit discharges through an RC circuit, so that the display unit displays an image with a single gray scale value. Thus, when the display panel displays dynamic images, no overlap occurs.

### BACKGROUND

The invention relates to a display panel, and in particular to a display unit displaying an image in advance and then displaying an image with a single gray scale value during a frame, thereby eliminating image overlap.

FIG. 1 shows a conventional display panel of a liquid crystal display (LCD) device. As shown in FIG. 1, a display panel 1 comprises a data driver 10, a scan driver 11, and a display array 12. The data driver 10 controls a plurality of data lines D₁ to Dₙ, and the scan driver 11 controls a plurality of scan lines S₁ to Sₘ. The display array 12 is formed by interlacing data lines D₁ to Dₙ and scan lines S₁ to Sₘ. Each set of the interlacing data and scan lines corresponds to one display unit, for example, interlacing data line D₁ and scan line S₁ correspond to a display unit 100. Referring to FIG. 2, as in conventional display units, the equivalent circuit of the display unit 100 comprises a switch transistor T10, a storage capacitor Cs10, and a liquid crystal capacitor Clc10.

The scan driver 11 sequentially outputs scan signals to scan lines S₁ to Sₘ according to a scan control signal. When receiving a scan signal, a scan line corresponding to a row turns on the switch transistors within all display units corresponding to the row, while the switch transistors within all display units corresponding to all other rows are turned off by other scan lines. When all switch transistors within all display units corresponding to a row are turned on, the data driver 10 outputs corresponding video signals with gray scale values to n display units corresponding to the row through the data lines D₁ to Dₙ according to image data prepared but not yet displayed. For example, when the scan driver 11 outputs a scan signal to the scan line S₁, the switch transistor T10 within the display unit 100 is turned on. The data driver 10 outputs a corresponding video signal to the display unit 100, and the storage capacitor Cs10 stores a voltage of the video signal. According to the voltage stored in the storage capacitor Cs10, the deflection angle of the liquid crystal molecules of the liquid crystal capacitor Clc10 can be determined, such that the amount of light from a backlight module of the LCD device can be determined.

A hold-driving method is conventionally used to control display units in LCD devices. Referring to FIG. 3, the illumination of a display unit remains the same during an entire frame, such as frame F11, using the hold-driving method. According to the circuitry, during the frame F11, the voltage stored in the storage capacitor Cs10 is held at a constant until a subsequent frame F12. However, the response time of the liquid crystal molecules is usually larger than a frame period. When the voltage of a video signal associated with the frame F12 is first stored in the storage capacitor Cs10, the voltage of a video signal associated with the frame F11 is still remain. Thus, when LCD devices display dynamic images, overlap of the images occurs.

Moreover, a display panel and a driving method thereof for a conventional organic light emitting display (OLED) device are the same as those in FIG. 1, with the only difference being the circuitry of display units. FIG. 4 shows circuitry of a display unit 400 in the OLED device. The display unit 400 comprises a switch transistor T40, a storage capacitor Cs40, a driving transistor T41, and a light-emitting diode (LED) D40. A hold-driving method is also used to control display units of OLED devices. Thus, when OLED devices display dynamic images, the overlap appearance of the images again occurs.

### SUMMARY

Display units are provided. Some embodiments of the display unit are applied in a display panel having a display array and comprising a switching element, a liquid crystal capacitor, a storage capacitor, and an impedance element. The display array is formed by at least one data line and at least one scan line. The switching element has a control terminal coupled to the scan line, an input terminal coupled to the data line, and an output terminal coupled to a pixel electrode. The liquid crystal capacitor is coupled between the pixel electrode and a common electrode. The storage capacitor is coupled between the pixel electrode and the common electrode. The impedance element is coupled between the pixel electrode and the common electrode.

Some embodiments of the display unit are applied in a display panel having a display array and comprising a switching element, a storage capacitor, an impedance element, a driving element, and a light-emitting element. The display array is formed by at least one data line and at least one scan line. The switching element has a control terminal coupled to the scan line, an input terminal coupled to the data line, and an output terminal coupled to a node. The storage capacitor is coupled between the node and a common electrode. The impedance element is coupled between the node electrode and the common electrode. The driving element has a control terminal coupled to the node, an input terminal coupled to a voltage source, and an output terminal. The light-emitting element is coupled between the output terminal of the driving element and the common electrode.

### DESCRIPTION OF THE DRAWINGS

The invention can be more fully understood by reading the subsequent detailed description and examples with references made to the accompanying drawings, wherein:

FIG. 1 shows a display panel of a conventional LCD device.

FIG. 2 is a circuit diagram of a display unit within the display panel in FIG. 1.

FIG. 3 is a diagram of illumination of a display unit driven by a hold-driving method.

FIG. 4 is a circuit diagram of a display unit of a conventional OLED device.

FIG. 5 shows an embodiment of a LCD device.

FIG. 6 shows voltage variation of a pixel electrode in FIG. 5.

FIG. 7 shows an embodiment of an OLED device.

FIG. 8 shows the voltage variation of a node N70 in FIG. 7.

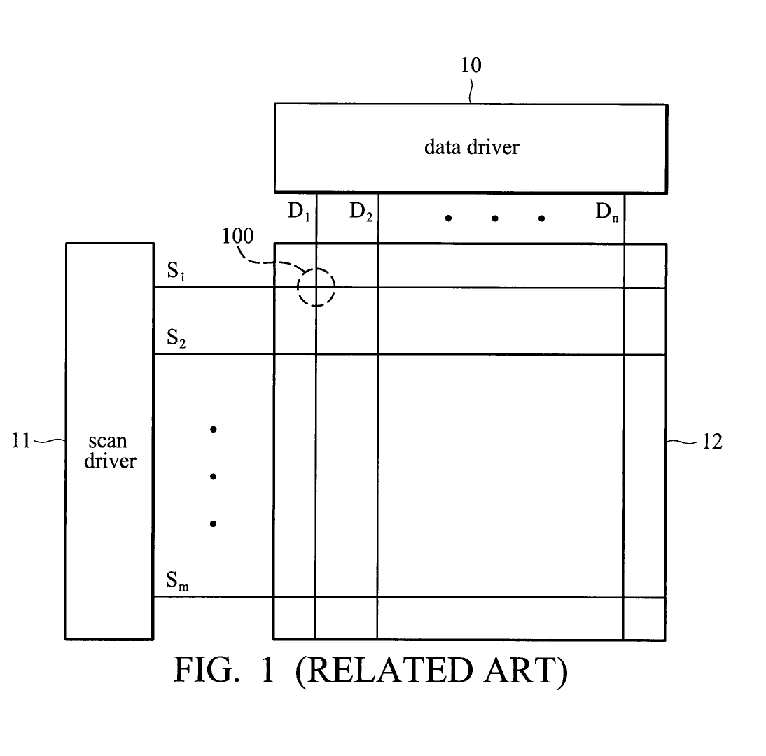

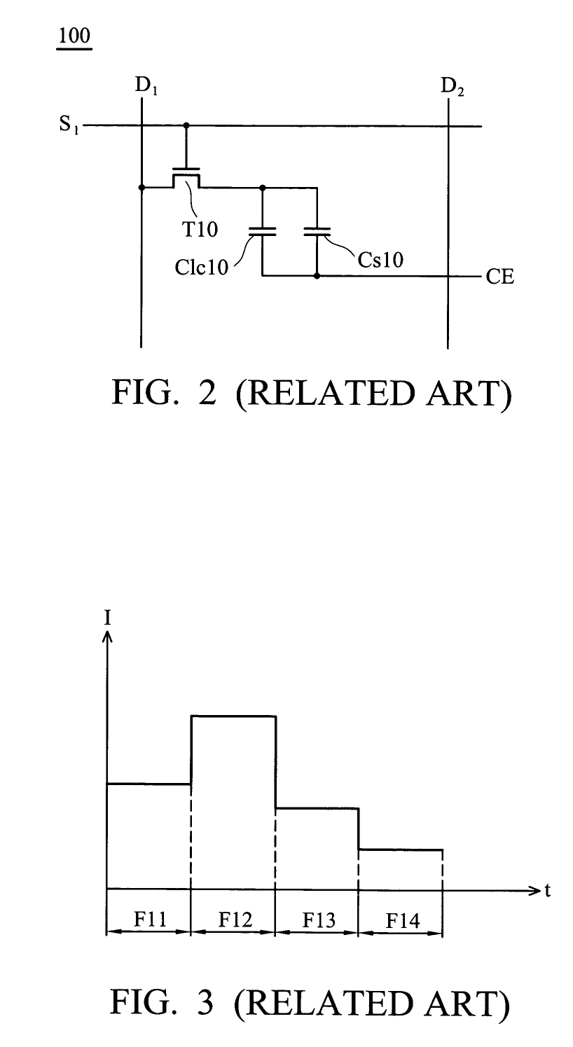

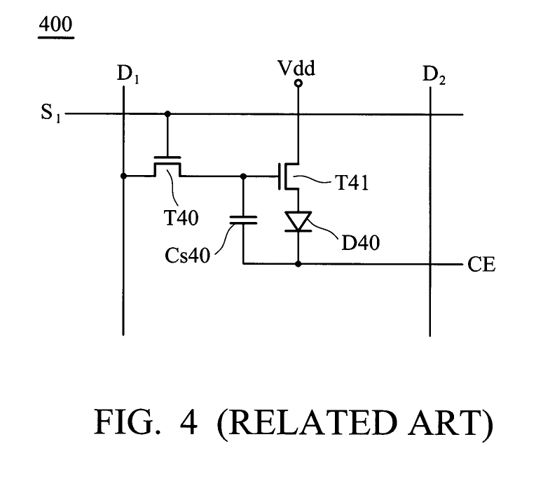

### DETAILED DESCRIPTION

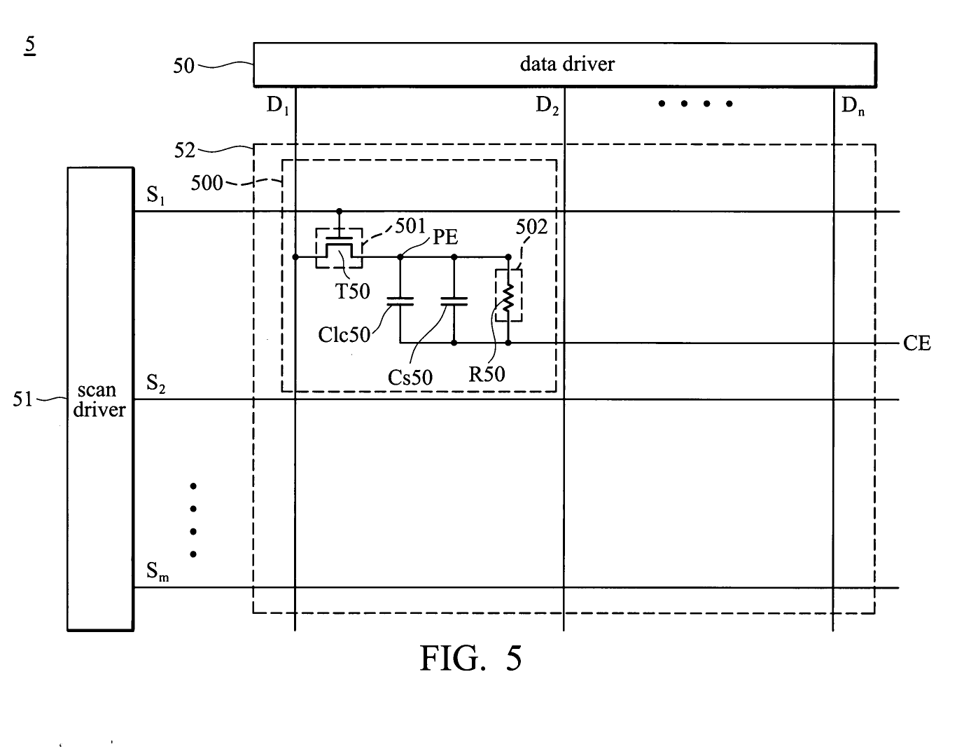

Embodiments of a display panels are provided. In some embodiments, as shown in FIG. 5, a display panel 5 of a LCD device is a normal black type, comprising a data driver 50, a scan driver 51, and a display array 52. The data driver 50 controls a plurality of data lines D₁ to Dₙ, and the scan driver 51 controls a plurality of scan lines S₁ to Sₘ. The display array 52 is formed by interlacing data lines D₁ to Dₙ and scan lines S₁ to Sₘ. Each set of interlacing data line and scan lines corresponds to one display unit, for example, the interlacing data line D₁ and scan line S₁ correspond to the display unit 500. Referring to FIG. 5, as in conventional display units, the equivalent circuit of the display unit 500 comprises a switching element 501, a storage capacitor Cs50, a liquid crystal capacitor Clc50, and an impedance element 502. In the embodiment of FIG. 5, the switching element 501 is implemented with a transistor T50. In other words, a gate, drain, and source of the transistor T50 serve as control, input, and output terminals of the switching element 501, respectively. The impedance element 502 comprises a resistor R50.

The gate of the transistor T50 is coupled to the scan line S₁, the drain thereof is coupled to the data line D₁, and the source thereof is coupled to a pixel electrode PE. The liquid crystal capacitor Clc50 is coupled between the pixel electrode PE and a common electrode CE. The storage capacitor Cs50 is coupled between the pixel electrode PE and the common electrode CE. The resistor R50 is coupled between the pixel electrode PE and the common electrode CE. The common electrode CE provides a voltage Vcom.

During a frame, when the LCD device is in a scan period, the scan driver 51 outputs a scan signal to the scan line S₁, and the transistor T50 is turned on. Then, the LCD device enters into a writing period, and the data driver 50 outputs a corresponding video signal to the display unit 500. The storage capacitor Cs50 stores a data voltage Vdata of the video signal. A voltage Vpx of the pixel electrode PE is result of (Vcom+Vdata). The liquid crystal molecules in the liquid crystal capacitor Clc50 deflect according to the data voltage Vdata. Referring to FIG. 5, the liquid crystal capacitor Clc50, the storage capacitor Cs50, and the resistor R50 make up an RC circuit. The storage capacitor Cs50 then begins to discharge from the data voltage Vdata, with the final voltage stored in the storage capacitor Cs50 equal to 0V finally. In other words, the voltage Vpx of the pixel electrode PE decreases from (Vcom+Vdata) to Vcom. At this time, the liquid crystal molecules in the liquid crystal capacitor Clc50 recover from the deflection.

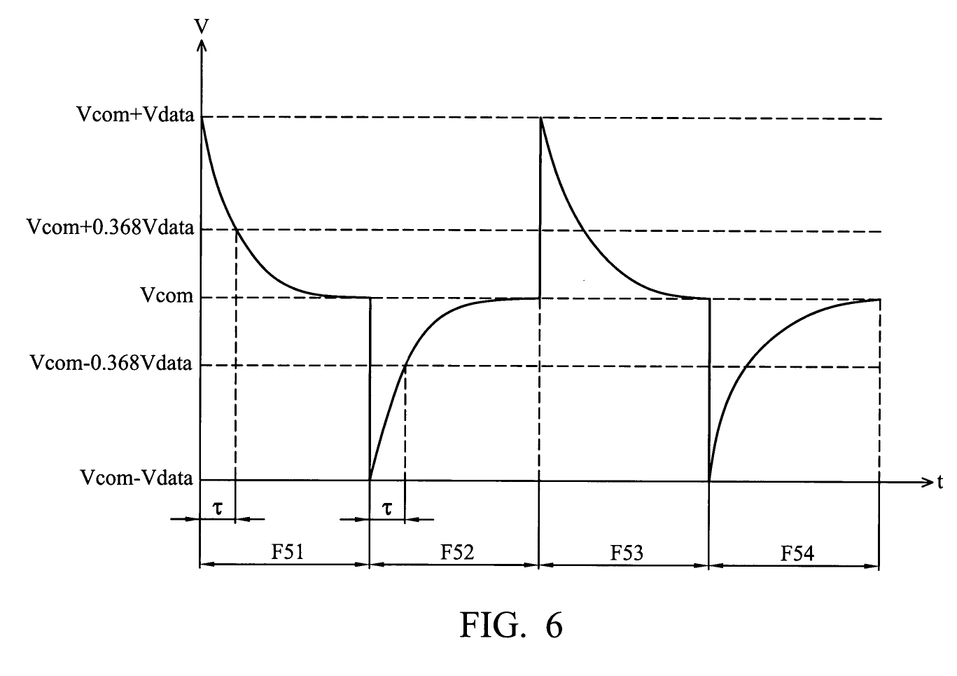

Referring to FIGS. 5 and 6, during a frame F51, the voltage Vpx rises to (Vcom+Vdata) by charging the storage capacitor Cs50. Then, the voltage Vpx decreases from (Vcom+Vdata) to Vcom due to the RC circuit composed of the liquid crystal capacitor Clc50, the storage capacitor Cs50, and the resistor R50. The time when the voltage Vpx decreases from (Vcom+Vdata) to (Vcom+0.368Vdata) is determined by the liquid crystal capacitor Clc50, the storage capacitor Cs50, and the resistor R50. Referring to FIG. 6, at the time τ, the voltage Vpx is equal to (Vcom+0.368Vdata), with the time τ represented by the following formula:
τ=r50×(clc50+cs50)

wherein r50 represents the value of the resistor R50, clc50 the value of the liquid crystal capacitor Clc50, and cs50 the value of the storage capacitor Cs50.

According to the above description, during the frame F51, the storage capacitor Cs50 stores the data voltage Vdata first, and then the storage capacitor Cs50 discharges totally, storing no voltage. Thus, the voltage Vpx of the pixel electrode PE decreases to equal to the voltage Vcom of the common electrode CE. Therefore, at the moment before a subsequent frame F52, the liquid crystal molecules in the liquid crystal capacitor Clc50 do not deflect, and the display unit 500 displays a black image (single gray scale value). When the display panel 5 is switched from the frame F51 to the frame F52, no overlap occurs.

Similarly, during the frame F52, the storage capacitor Cs50 of the display unit 500 also performs the discharge process. It is noted that the data voltage of the video signal is negative, as shown in FIG. 6, due to continuous bias with single polarity shortening the life of liquid crystal molecules. To avoid this, display units within odd and even frames are driven alternately with positive and negative video signals.

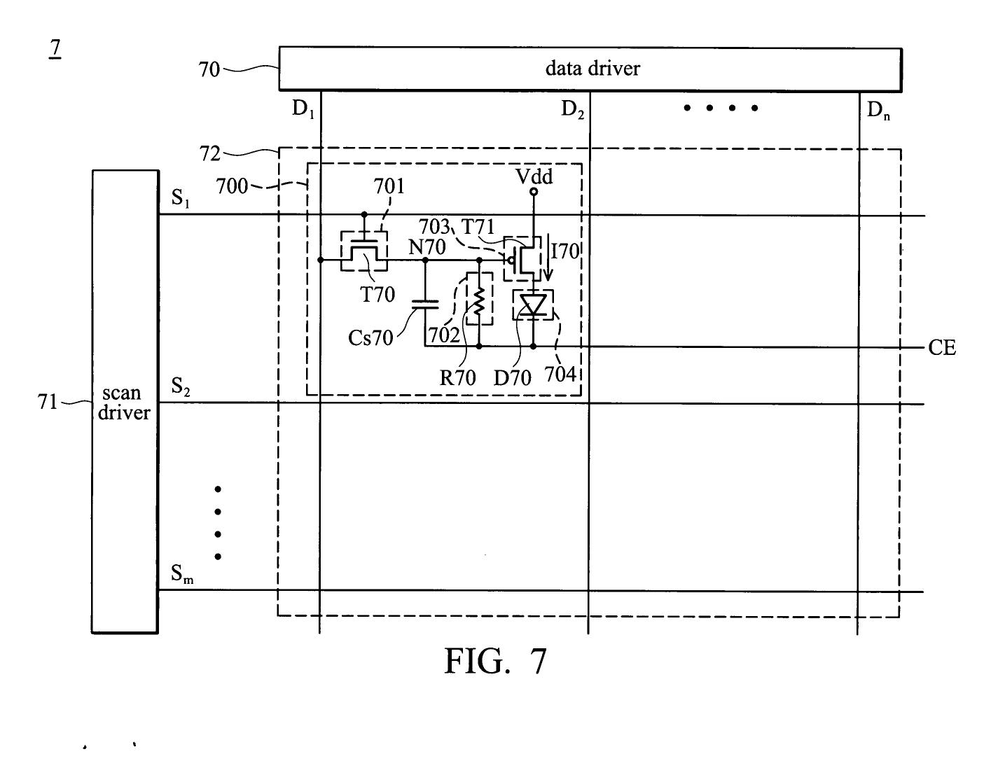

Some embodiments of a display panels are provided. In some embodiments, as shown in FIG. 7, a display panel 7 of an OLED device comprises a data driver 70, a scan driver 71, and a display array 72. The data driver 70 controls a plurality of data lines D₁ to Dₙ, and the scan driver 71 controls a plurality of scan lines S₁ to Sₘ. The display array 72 is formed by interlacing data lines D₁ to Dₙ and scan lines S₁ to Sₘ. Each set of the interlacing data and scan lines corresponds to one display unit, for example, the interlacing data line D₁ and scan line S₁ correspond to the display unit 700. Referring to FIG. 7, like any other display unit, the equivalent circuit of the display unit 700 comprises a switching element 701, a storage capacitor Cs70, an impedance element 702, a driving element 703, and a light-emitting element 704. In the embodiment on FIG. 7, the switching element 701 is implemented with a transistor T70. In other words, a gate, drain, and source of the transistor T70 serve as a control, input, and output terminal of the switching element 701, respectively. The driving element 703 is implemented with a transistor T71. In other words, a gate, drain, and source of the transistor T71 serve as control, input, and output terminals of the driving element 703, respectively. The impedance element 702 comprises a resistor R70. The light-emitting element 704 is implemented with an LED D70.

The gate of the transistor T70 is coupled to the scan line S₁, the drain thereof is coupled to the data line D₁, and the source thereof is coupled to a node N70. The storage capacitor Cs70 is coupled between the node N70 and a common electrode CE. The resistor R70 is coupled between the node N70 and the common electrode CE. The gate of the transistor T71 is coupled to the node N70, and the drain thereof is coupled to a voltage source Vdd. The LED D70 is coupled between a source of the transistor T71 and the common electrode CE. The common electrode CE provides a voltage Vcom.

During a frame, when the OLCD device is in a scan period, the scan driver 71 outputs a scan signal to the scan line S₁, and the transistor T70 is turned on. Then, the OLCD device enters gets into a writing period, and the data driver 70 outputs a corresponding video signal to the display unit 700. The storage capacitor Cs70 stores a data voltage Vdata of the video signal. A voltage V70 of the node N70 is the result of (Vcom+Vdata). The transistor T71 is turned on according to (Vcom+Vdata) and produces a current I70 to drive the LED D70 to emit light. Referring to FIG. 7, the storage capacitor Cs70 and the resistor R70 make up an RC circuit. The storage capacitor Cs70 then begins to discharge from the data voltage Vdata, with and the final voltage stored in the storage capacitor Cs50 equal to 0V. In other words, the voltage V70 of the node N70 decreases from (Vcom+Vdata) to Vcom. When the voltage V70 is lower than the threshold voltage of the transistor T71, the transistor T71 is turned off, and LED D70 stops emitting light.

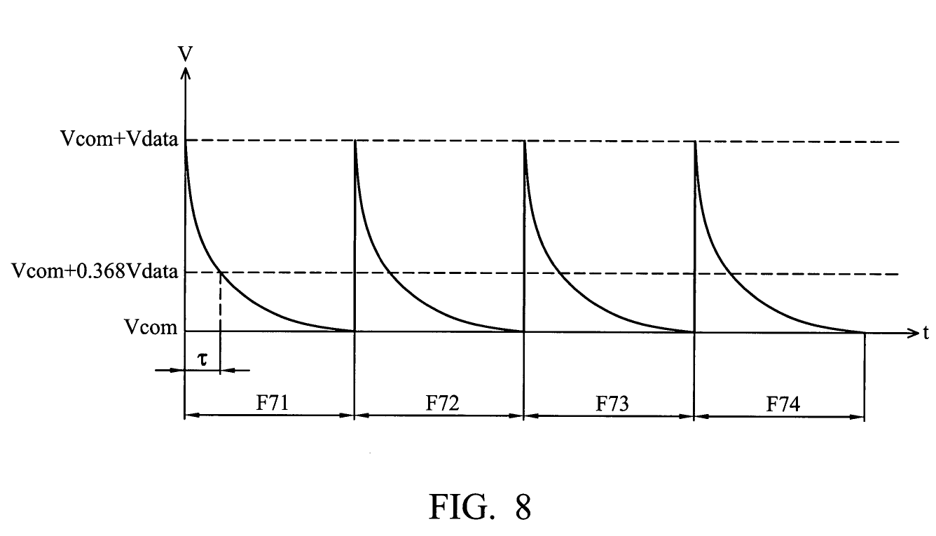

Referring to FIGS. 7 and 8, during a frame F71, the voltage V70 rises to (Vcom+Vdata) by charging the storage capacitor Cs70. Then, the voltage V70 decreases from (Vcom+Vdata) to Vcom due to the RC circuit composed of the storage capacitor Cs70 and the resistor R70. The time when the voltage V70 decreases from (Vcom+Vdata) to (Vcom+0.368Vdata) is determined by the storage capacitor Cs70 and the resistor R70. Referring to FIG. 8, at the time τ, the voltage V70 is equal to (Vcom+0.368Vdata), with the time τ represented by the following formula:
τ=r70×cs70

wherein r70 represents the value of the resistor R70, and cs70 represents the value of the storage capacitor Cs70.

According to the above description, during the frame F71, the storage capacitor Cs70 stores the data voltage Vdata first, and then the storage capacitor Cs70 discharges totally, storing no voltage. Thus, the voltage V70 of the node N70 decreases to the voltage Vcom of the common electrode CE. Therefore, at the moment before a subsequent frame F72, the transistor T71 is turned off, and the LED D70 stops emitting light. The display unit 700 displays a black image. When the display panel 7 is switched from the frame F71 to the frame F72, no overlap occurs.

Similarly, during the frame F72, the storage capacitor Cs70 of the display unit 700 also performs the above discharging process. At the moment before a subsequent frame F73, the transistor T71 is turned off, and the LED D70 stops emitting light. The display unit 700 displays a black image.

According to some embodiments of display panels of LCD and OLED devices, during a frame, a display unit displays a corresponding image first. Then, before a subsequent frame, the display unit displays a black image due to a discharge process of a storage capacitor within the display unit. Although the LCD and OLED devices display dynamic images by hold-driving method, no overlap occurs.

Finally, while the invention has been described by way of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A display unit for a display panel having a display array formed by at least one data line and at least one scan line, comprising:
a switching element having a control terminal coupled to the scan line, an input terminal coupled to the data line, and an output terminal coupled to a pixel electrode;
a liquid crystal capacitor coupled between the pixel electrode and a common electrode;
a storage capacitor coupled between the pixel electrode and the common electrode; and
an impedance element coupled between the pixel electrode and the common electrode.

2. The display unit as claimed in claim 1, wherein during a first frame, the storage capacitor stores a data voltage and then discharges the data voltage.

3. The display unit as claimed in claim 2, wherein before a second frame following the first frame, the voltage stored in storage capacitor decreases to 0V.

4. The display unit as claimed in claim 2, wherein the liquid crystal capacitor, the storage capacitor, and the impedance element make up an RC circuit.

5. The display unit as claimed in claim 4, wherein the impedance element comprises a resistor.

6. The display unit as claimed in claim 1, wherein in a writing period, the storage capacitor stores a data voltage and then is discharged from the data voltage.

7. The display unit as claimed in claim 6, wherein in a scan period before the writing period, the switching element is turned on.

8. The display unit as claimed in claim 6, wherein the liquid crystal capacitor, the storage capacitor, and the impedance element make up an RC circuit.

9. The display unit as claimed in claim 8, wherein the impedance element comprises a resistor.

10. A display unit for a display panel having a display array formed by at least one data line and at least one scan line, comprising:
a switching element having a control terminal coupled to the scan line, an input terminal coupled to the data line, and an output terminal coupled to a node;
a storage capacitor coupled between the node and a common electrode;
an impedance element coupled between the node electrode and the common electrode;
a driving element having a control terminal coupled to the node, an input terminal coupled to a voltage source, and an output terminal; and
a light-emitting element coupled between the output terminal of the driving element and the common electrode.

11. The display unit as claimed in claim 10, wherein during a first frame, the storage capacitor stores a data voltage and then is discharged from the data voltage.

12. The display unit as claimed in claim 11, wherein before a second frame following the first frame, the voltage stored in storage capacitor decreases to 0V.

13. The display unit as claimed in claim 11, wherein the driving element comprises a transistor.

14. The display unit as claimed in claim 11, wherein the storage capacitor and the impedance element make up an RC circuit.

15. The display unit as claimed in claim 14, wherein the impedance element comprises a resistor.

16. The display unit as claimed in claim 10, wherein in a writing period, the storage capacitor stores a data voltage and then is discharged from the data voltage.

17. The display unit as claimed in claim 16, wherein in a scan period before the writing period, the switching element is turned on.

18. The display unit as claimed in claim 16, wherein the driving element comprises a transistor.

19. The display unit as claimed in claim 16, wherein the storage capacitor and the impedance element make up an RC circuit.

20. The display unit as claimed in claim 19, wherein the impedance element comprises a resistor.
